(19) United States
(12) Patent Application Publication
(10) Pub. No.: US 2024/0112189 A1
(43) Pub. Date: Apr. 4, 2024

(54) INTEGRATED LOYALTY VISION FOR TRANSACTIONS

(71) Applicant: NCR Voyix Corporation, Atlanta, GA (US)

(72) Inventors: Gal Ariav, Ein Vered (IL); Yana Kidon, Atlanta, GA (US); Dani Gilburt, Atlanta, GA (US); Kate Ofir, Atlanta, GA (US); Elran Oved, Atlanta, GA (US); Sergei Rozenfeld, Atlanta, GA (US)

(21) Appl. No.: 17/957,507

(22) Filed: Sep. 30, 2022

(51) Int. Cl. G06Q 20/40

(52) U.S. Cl. CPC G06Q 20/40145

(57) ABSTRACT

A customer is enrolled for facial recognition that links the customer's face to their loyalty identifier for their loyalty account with a loyalty system of a store. Enrollment occurs during a first transaction at a transaction terminal. For subsequent transactions at the terminal or other terminals, an image of the customer's face is captured, the image is mapped to the customer's enrolled loyalty identifier, and the loyalty identifier is injected into the transaction workflows causing the subsequent transactions to be personalized for the customer based on the customers loyalty details and causing the transaction details for the subsequent transactions to be associated with the customer's loyalty account. Loyalty is integrated into the subsequent transactions of the customer in a frictionless and contactless manner that requires no affirmative actions by the customer.

### BACKGROUND

Most retailers have loyalty programs that they offer to their customers. The customer agrees to let the retailer track their purchases with the retailer and in exchange the customer can earn rewards, such as discounts, free items, and/or options to purchase goods with accumulated loyalty points. The retailer is able to customize offers to their customers using transaction histories and analyze transaction patterns to improve sales and operations of stores using transaction histories. The customers present their loyalty card or provide/enter identifying information linked to their loyalty accounts during a checkout; this allows the retailer to link the customers to their loyalty accounts during transactions.

Unfortunately, customers do not use their loyalty cards with the frequency that retailers would like to see. This can be for a variety of reasons such as a customer is in a hurry and does not want to waste time associated with providing their card/identifying information; because of COVID-19 the customer is reluctant to touch the checkout any more than is necessary and/or prefers to reduce their interaction time with a cashier during the checkout; some retailers may require a Personal Identification Number (PIN) be entered by the customer before linking the customer's account and the customer perceives this to be a waste of time; the customer may not be in possession of their loyalty card during the checkout and may not remember correctly what identifying information is linked to the account for purposes of linking their account; the customer may have thrown their loyalty card away because the customer believed they had too many loyalty cards with too many retailers and they were taking up space either at home, in their car, or in their wallet/purse, etc.

As a result, retailers have an incomplete picture of their customers since the customers are not using their loyalty cards as frequently as the retailers would like. Thus, a retailer's system, which is associated with customer-relationship management (CRM), relies on and analyzes incomplete transaction data for their customers, which means the services of the retailer provided to their customer through their CRM system are not optimal nor accurate.

### SUMMARY

In various embodiments, a system and methods for integrated loyalty vision for transactions are presented. A new loyalty customer or an existing loyalty customer is enrolled in a frictionless cloud-based loyalty service. During enrollment an image of a customer's face is captured by a camera associated with a transaction terminal during a checkout after the customer consents via a transaction interface screen to enroll in the frictionless cloud-based loyalty service. A machine-learning model (MLM) is trained on the image and a loyalty account created or maintained by a loyalty system is linked to the image.

After successful enrollment, the customer approaches a transaction terminal for a checkout and a camera captures an image of the customer's face; the frictionless cloud-based service receives the image and provides the image to the MLM. The MLM outputs a value that is linked to the customer's loyalty identifier (e.g., loyalty account identifier), The frictionless cloud-based loyalty service returns the loyalty identifier to the transaction terminal, which reports the loyalty identifier to the loyalty system. The loyalty system returns loyalty details back to the transaction terminal based on the customer's loyalty account; for example, the loyalty details can include a customer name, a customer profile, customer preferences, and/or custom transaction settings associated with the customer, etc. The loyalty account of the customer is linked to the transaction for any customizations processed by the transaction terminal and for recording/linking the transaction details associated with the checkout to the customer's loyalty account.

### BRIEF DESCRIPTION OF THE DRAWINGS

FIG. 1A is a diagram depicting a process flow for enrolling a customer in frictionless loyalty vision integration during a checkout, according to an example embodiment.

FIG. 1B is a diagram depicting a process flow for providing frictionless loyalty vision integration during a next checkout after enrollment, according to an example embodiment.

FIG. 1C is a diagram of a system for frictionless loyalty vision transaction integration during checkouts, according to an example embodiment.

FIG. 2 is a flow diagram of a method for processing frictionless loyalty vision transaction integration during a checkout, according to an example embodiment.

FIG. 3 is a flow diagram of another method for processing frictionless loyalty vision transaction integration during a checkout, according to an example embodiment.

### DETAILED DESCRIPTION

As stated above, retailers struggle with voluntary customer compliance in providing loyalty account information during checkouts so that a customer's transaction data for a checkout can be properly linked to the customer's loyalty account. Increased participation rates are difficult to achieve because conventional approaches require affirmative actions be taken by the customers and/or require the customers be in possession of a loyalty card during the checkouts.

The teachings provided herein provide cloud-based vision processing that automatically causes a customer's loyalty account to be linked to a customer's transaction during a checkout. Any customizations associated with the customer's loyalty details can be integrated into the transaction by the transaction terminal without the customer taking any affirmative action to associate the transaction with the customer's loyalty account. Moreover, the transaction terminal updates the loyalty account through the corresponding loyalty system with the customer's transaction details following the checkout without the customer taking any affirmative action to identify the customer's loyalty account. Therefore, integration of a customer's loyalty identifier for the customer's loyalty account with a transaction during a checkout at a transaction terminal is achieved in a frictionless manner, meaning the customer does not perform any affirmative actions to link the account to the transaction.

Furthermore, if the checkout is through a point-of-sale (POS) terminal operated by a cashier as a cashier-assisted transaction, the cashier is not interrupted to obtain a loyalty card or loyalty identifying information from the customer during the checkout. Also, if the checkout is a self-service terminal (SST) operated by the customer as a self-checkout, the customer does not have to touch any of the peripherals or touch-display for purposes of providing their loyalty card and/or entering loyalty identifying information. Thus, the techniques described herein and below for integrating a customer's loyalty account within a workflow of a transaction are both frictionless and contactless.

The customer's loyalty identifier is determined via facial recognition using an image taken of the customer when the customer is in front of or adjacent to a transaction terminal for a checkout. The image is provided to a trained MLM and the MLM returns a value, which was previously linked to the customer's loyalty identifier during enrollment of the customer where the customer provided a consent to use facial recognition. The loyalty identifier is provided to the transaction terminal during the transaction associated with the checkout. The transaction terminal uses the loyalty identifier to obtain loyalty details from a loyalty system associated with the loyalty account, which is linked to the loyalty identifier. Transaction customizations are made by the transaction terminal for the customer based on the loyalty details and the transaction details for the checkout are provided by the transaction terminal to the loyalty system.

The teachings provided herein provide a dynamic and real-time technique by which one or more unique objects are identified from an image of image frames of a video feed captured of the physical environment during AR session initiation of the physical environment. The unique objects are detected based on matching unique features known for the objects to the image or video feed of the physical environment. The display depicts the image, or the video feed captured within the screen using a field-of-view of a camera, which is providing the image or video video feed for during AR session initiation. A two-dimensional (2D) array is generated and maintained to map the unique objects to screen positions on a display; for example, x pixel (width) coordinates and y pixel (height) coordinates of the image or video feed. A physical object within the physical environment is detected within the image of the video feed based on the unique objects and their positions maintained within the 2D array and based on the physical object being linked to a computer-aided design (CAD) model (hereinafter the physical object associated with the CAD model is referred to as the “CAD-based object”). The CAD model is used to derive a 3D array or matrix. An origin of the object that corresponds to the CAD model is predicted and calculated within the image of the video feed using the unique objects and their screen positions on the display relative to the CAD-based object. CAD coordinates associated with the unique objects are added to the 2D array. Positions or locations of the objects including features of interest associated with the objects are added to the 3D array. The pose of the CAD-based object is derived from the 2D and 3D arrays and provided to an AR application during session initiation for an AR session with a user.

A “transaction terminal” and/or “terminal is intended to mean a processing device with a variety of peripherals that perform transactions on behalf of customers at a retail site. The peripherals include, by way of example only, a touch display, a PIN pad, a key pad, a receipt printer, a card reader, a produce weigh scale, a bag weigh scale, a horizontal scanner, a vertical scanner, a bioptic scanner, a handheld scanner, a cash drawer, a cash and coin handling device for accepting currency as payment and for dispensing currency as change, and/or a near-field communication (NFC) transceiver for contactless card reading, a. A terminal can include an SST, a POS terminal, a kiosk, or an automated teller machine (ATM).

The terms “customer” and/or “user” may be used interchangeably and synonymously with one another. This refers to an individual that is being checkout for a transaction. An “operator” refers to the individual that is interacting with the terminal to perform the checkout. A customer is the operator during self-service transactions at an SST. Conversely, a cashier is the operator during cashier-assisted transactions at a POS terminal.

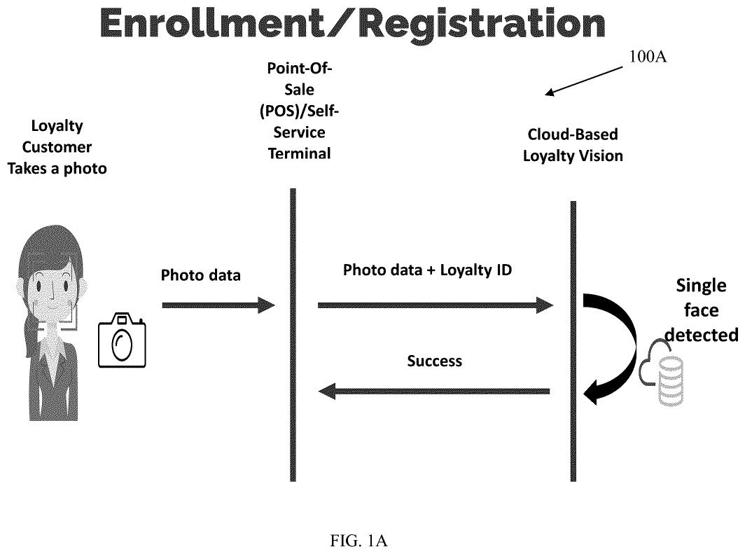

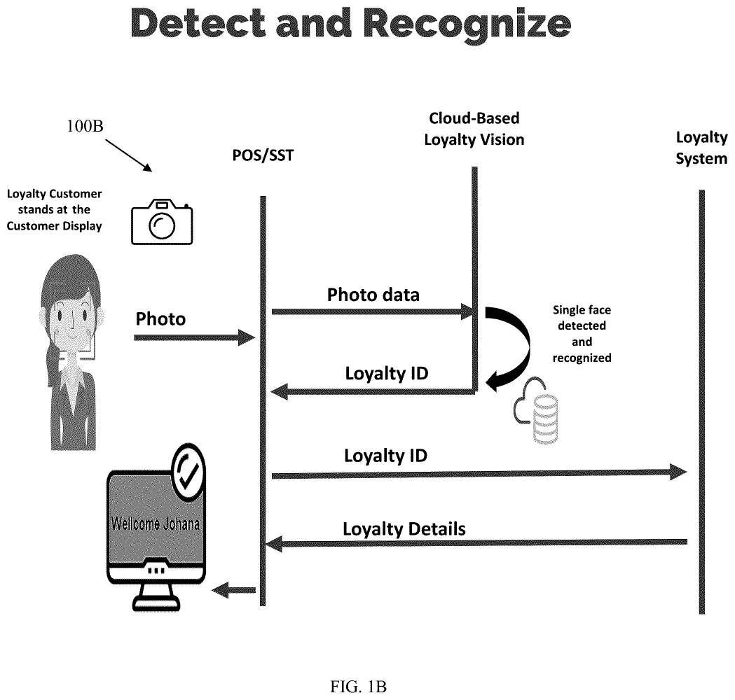

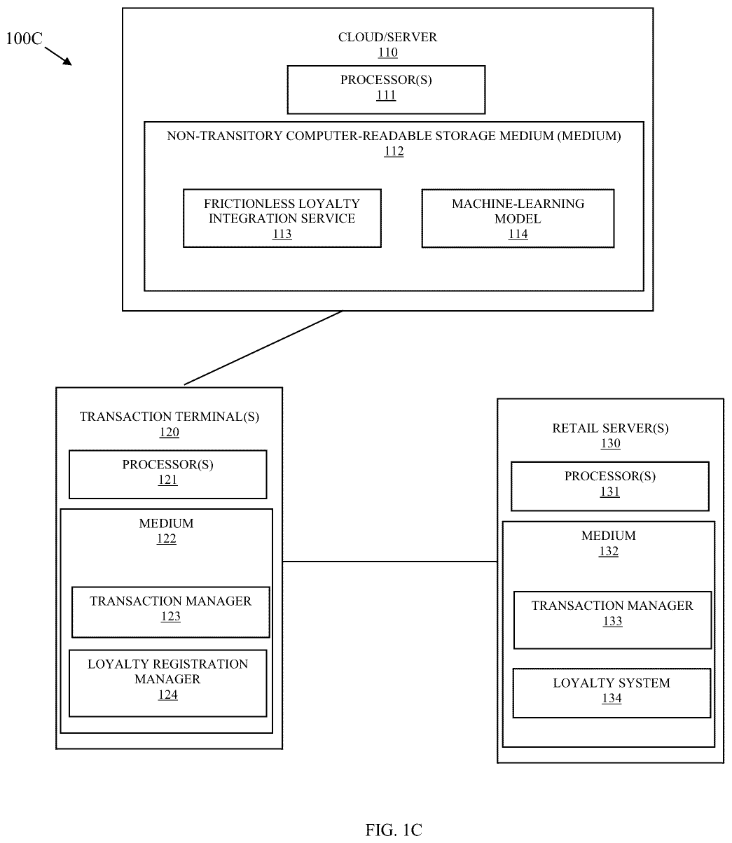

FIG. 1A is a diagram depicting a process flow 100A for enrolling a customer in frictionless loyalty vision integration during a checkout, according to an example embodiment. During a checkout, a customer provides a loyalty card or enters loyalty identifying information for a transaction at a terminal. A workflow associated with the transaction manager of the terminal is enhanced to present a transaction interface screen to the customer requesting consent of the customer to enroll the customer in a frictionless loyalty integration service that relies on images taken of the customer's face. When the customer provides consent through the transaction interface screen, the transaction manager obtains and image of the customer from a camera that is situated in front of the customer and/or adjacent to the terminal.

The enhanced workflow causes the transaction manager to use an Application Programming Interface (API) and issue a call to the frictionless loyalty integration service, shown as Cloud-Based Loyalty Vision in FIG. 1A. The API call includes the customer's loyalty identifier, the consent of the customer, and the image of the customer's face. An MLM is trained on the image of the customer's face to either return the customer loyalty identifier or to return a score that is mapped to the customer loyalty identifier based on facial features of the customer detected in the image. This training can be done with a single image of the customer's face. The frictionless loyalty integration service retains the loyalty identifier and the corresponding customer consent and returns, through the API, a success message, which causes the transaction manager to present within a transaction interface screen a confirmation that the customer is now enrolled for the frictionless loyalty integration service.

In an embodiment, a customer who does not yet have a loyalty account is presented with transaction interface screens for to register for a loyalty account. In this situation, the transaction interface screens are enhanced to also inquire of the customer as to whether the customer wants to enroll in the frictionless loyalty integration service for which the customer's consent is required. The initial registration workflow is enhanced to include the disclosure/consent request, to obtain the facial image of the customer captured from the camera, provide the loyalty identifier assigned by the loyalty system for the new registration, and send through an API call, the loyalty identifier, the customer's consent, and the facial image to the frictionless loyalty integration service. The frictionless loyalty integration service stores the loyalty identifier, stores the customer's consent, trains the MLM on the facial image, and returns a success message back to the terminal. The terminal presents a confirmation message through a transaction interface screen to the customer.

Each subsequent time that the customer checkouts out at a terminal, the customer can have their loyalty identifier and corresponding loyalty details integrated into and associated with the corresponding transactions. Again, this is achieved without any affirmative action being required of the customer in a frictionless and contactless manner.

FIG. 1B is a diagram depicting a process flow 100B for providing frictionless loyalty vision integration during a next checkout after enrollment, according to an example embodiment. After enrollment and/or registration, a customer can perform checkouts and have their loyalty identifier and loyalty details associated with their loyalty account automatically injected into and integrated within the transaction workflow for the transactions during the checkouts.

The registered customer is in front of a terminal for a checkout, the transaction manager obtains a facial image of the customer from the camera and sends the facial image to the frictionless loyalty integration service, referred to as Cloud-Based Loyalty Vision in FIG. 1B. Frictionless loyalty integration service provides the facial image to the MLM and the MLM returns a score or returns the loyalty identifier for the customer based on matching features of the customer face to features identified during training. When a score is returned, the frictionless loyalty integration service matches the loyalty identifier based on the score being within a predefined range. For example, frictionless loyalty integration service can maintain a table, each row of the table includes a score and a customer loyalty identifier; the score returned from the MLM is used to search the table within the predefined range and identify the specific loyalty identifier for the customer associated with the facial image provided.

When a match of the facial image is associated with an enrolled loyalty identifier. Frictionless loyalty integration service uses an API to inject the loyalty identifier back in to the transaction workflow being processed by the transaction manager of the terminal for the checkout. The transaction manager uses the loyalty identify to obtain the loyalty details for the loyalty account associated with the customer from the loyalty system. The loyalty system returns the loyalty details back to the transaction manager. The loyalty details can be processed to customize and to personalize the transaction during the checkout. For example, the display shown on the bottom righthand side of FIG. 1B includes the phrase “Welcome Johana,” which can be the name of the customer associated with the checkout. Transaction details associated with the transaction are now linked to the customer's loyalty account via the loyalty identifier that appears in the transaction details such that the loyalty system can update the customer's loyalty account following the checkout with the transaction details using existing workflows that the loyalty system relies on for updating its loyalty accounts using transaction histories of transactions.

A non-match of the facial image to any known loyalty identifiers can indicate that the customer is not enrolled, in which case no further action takes place and the facial image is deleted. The frictionless loyalty integration service does not respond to the image provided by the transaction manager when a facial image is not matched to any enrolled loyalty identifiers. In this case, the transaction manager processes the transaction workflow normally because no loyalty identifier was returned from the frictionless loyalty integration service.

FIG. 1C is a diagram of a system 100C for frictionless loyalty vision transaction integration during checkouts, according to an example embodiment. It is to be noted that the components are shown schematically in greatly simplified form, with only those components relevant to understanding of the embodiments being illustrated.

Furthermore, the various components (that are identified in FIG. 1C) are illustrated and the arrangement of the components is presented for purposes of illustration only. It is to be noted that other arrangements with more or less components are possible without departing from the teachings of frictionless loyalty vision transaction integration presented herein and below.

System 100 includes a cloud 110 or a server 110 (hereinafter referred to as “cloud 110”), one or more transaction terminals 120, and one or more retail servers 130. Cloud 110 includes at least one processor 111 and a non-transitory computer-readable storage medium (hereinafter referred to as “medium”), which includes executable instruction for a frictionless loyalty integration service 113 and an MLM 114. The instructions when obtained by or provided to processor 111 cause processor 111 to perform operations discussed herein and below for frictionless loyalty integration service 113 and MLM 114.

Each transaction terminal 120 (hereinafter referred to as “terminal 120”) includes at least one processor 121 and medium 122, which includes executable instructions for a transaction manager 123 and a loyalty registration manager 124. The instructions when obtained by or provided to processor 121 cause processor 121 to perform operations discussed herein and below for transaction manager 123 and loyalty registration manager 124.

Each retail server 130 includes at least one processor 131 and medium 132, which includes executable instructions for a transaction manager 133 and a loyalty system 134. The instructions when obtained by or provided to processor 131 cause processor 131 to perform operations discussed herein and below for transaction manager 133 and loyalty system 134. It is noted that loyalty system 134 can include multiple cooperating applications, services, and interfaces that together provide loyalty account management for a retailer.

A transaction workflow associated with transaction manager 123 is modified to detect during a transaction when a customer provides a loyalty identifier. The workflow presents a transaction interface screen during the transaction to the customer asking the customer if the customer wants to participate in loyalty integration for transactions by registering an image of the customer's face with frictionless loyalty integration service 113 and by consenting to allowing the loyalty integration service 113 to capture and recognizes images of the customer's face during checkouts. When the customer consents a camera is activated, and a facial image of the customer is captured. Transaction manager 123 uses an API to send the consent, the facial image, and the customer's loyalty identifier to frictionless loyalty integration service 113.

Frictionless loyalty integration service 113 (herein after referred to as “integration service 113”) stores the customer's loyalty identifier along with the consent and trains the MLM 114 on the image to produce as output a score for the facial image. The score is then matched to the loyalty identified in a record maintained by integration service 113 for the customer. The record includes, the loyalty identifier, the consent, and the score outputted by the MLM 114. The record may also include a threshold range that the score outputted by the MLM 114 is compared to and if the score is within that range, the integration service 113 considers that to be a match on the customer's loyalty identifier within the customer record.

When a customer does not have a loyalty account with the store, transaction manager 123 initiates a sub workflow during a transaction for loyalty registration manager 124. The customer is presented transaction interface screens for registering for a loyalty account and a corresponding loyalty identifier. Loyalty registration manager 124 interacts with loyalty system 134 to register the customer and to assign the customer a loyalty account with a loyalty identifier. The loyalty registration manager 124 may be modified to ask through an interface screen as to whether the customer wants to consent to frictionless loyalty transaction integration by providing a facial image and registering with integration service 113. When the customer consents, loyalty registration manager 124 and/or transaction manager 124 makes an API call to integration service 113 with the customer's consent, the facial image, and the loyalty identifier. Integration service 113 generates a customer record, stores the consent in the record, stores the loyalty identifier in the record, trains the MLM 114 on the facial image, stores the score returned from the MLM 114 in the record, and optional/y stores a threshold ranges to compare against the store in the record.

When an enrolled customer approaches a same terminal 120 or a different terminal of the store for a next transaction after enrollment with the integration service 113, transaction manager 123 causes a camera to capture a facial image of the customer. The image is sent using the API to integration service 113. Integration service 113 passes the facial image to MLM 114 and receives a score. The score is searched in the enrolled customer records and optionally compared in view of a threshold range when a match is detected, integration service 113 obtains the loyalty identifier and uses the API to inject the loyalty identifier into the workflow of transaction manager 123. Transaction manager 123 identifies the loyalty identifier and interacts with loyalty system 134 to obtain the customer's loyalty account and loyalty details. For example, a name of the customer, preferred method of payment, a preference to redeem any loyalty points available with the current transaction, preferred language to communicate with the customer, etc. Transaction manager 123 personalizes the transaction based on the returned loyalty details. Transaction manager 123 interacts with transaction manager 133 of retail service 130 to complete the transaction and the transaction details are associated with the customer's loyalty account using the loyalty identifier integrated into the transaction details.

In an embodiment, the camera captures a live video feed of the face of the customer and the video feed is provided by the transaction manager to integration service 113. Integration service obtains multiple image frames from the video feed and trains the MLM 114 on a plurality of images frames. Similarly, in a transaction following enrollment, the integration service 113 passes one or more image frames from the video feed to the MLM 114 to produce the score for the customer that is then matched with the customer record.

In an embodiment, the integration service 113 is provided as a micro service within a micro service architecture that can be called within the workflow for the transaction manager 123. The integration service 113 requires no interaction with the loyalty system 134 and merely registers a loyalty identifier and facial image for a customer during enrollment and provides the transaction workflow the loyalty identifier matched during transactions following customer enrollment.

In an embodiment, images of customers that are not matched by frictionless integration services are discarded and deleted. This is an indication of a customer performing a transaction who has not authorized facial recognition by integration service 113. In this case, integration service 113 may affirmatively send a message back to transaction manager 123 that no loyalty identifier was found or may not respond at all. Transaction manager 123 may be configured to set a timer and when the time expires without a loyalty identifier being returned by integration service 113, transaction manager 123 assumes the current transaction is for a customer that is not registered in the loyalty system or may be registered but did not authorize registration with integration service 113.

In an embodiment, the transaction are self-service transactions performed by a customer at an SST. In an embodiment, the transaction is cashier-assisted transactions performed by a cashier on behalf of a customer at a POS terminal. For cashier-assisted transactions, the camera faces the customer directly based on where the customer stands at the POS terminal during the cashier-assisted transactions.

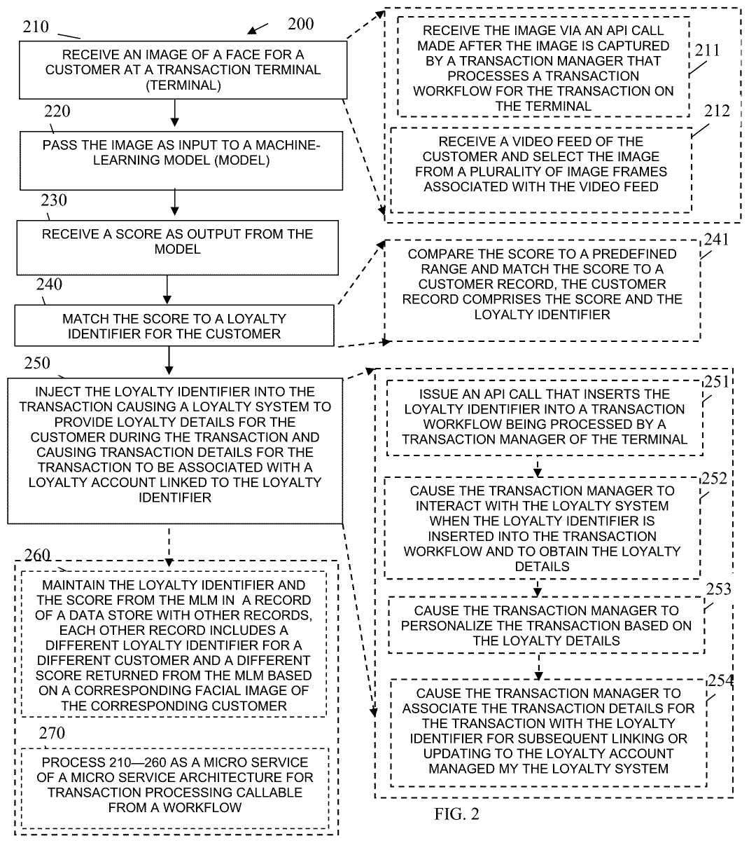

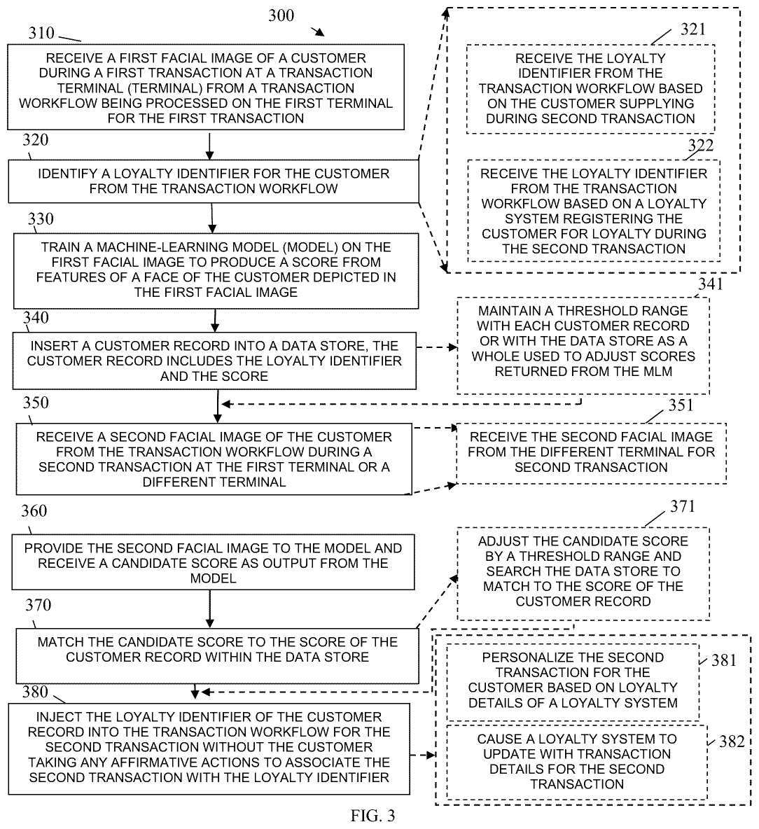

The above-referenced embodiments and other embodiments are now discussed with reference to FIGS. 2 and 3. FIG. 2 is a flow diagram of a method 200 for processing frictionless loyalty vision transaction integration during a checkout, according to an example embodiment. The software module(s) that implements the method 200 is referred to as a “frictionless loyalty identifier integration manager.” The frictionless loyalty identifier integration manager is implemented as executable instructions programmed and residing within memory and/or a non-transitory computer-readable (processor-readable) storage medium and executed by one or more processors of one or more devices. The processor(s) of the device(s) that executes the frictionless loyalty identifier integration manager are specifically configured and programmed to process the frictionless loyalty identifier integration manager. The frictionless loyalty identifier integration manager has access to one or more network connections during its processing. The connections can be wired, wireless, or a combination of wired and wireless.

In an embodiment, the device that executes frictionless loyalty identifier integration manager is cloud 110. In an embodiment, the device that executes frictionless loyalty identifier integration manager is server 110. In an embodiment, the devices that executes frictionless loyalty identifier integration manager is a retail server 130. In an embodiment, the frictionless loyalty identifier integration manager is all of, or some combination of 113 and/or 114. In an embodiment, the frictionless loyalty identifier integration manager is provided to a retail server 130 and/or a a retailer service/system as a software-as-a-service (SaaS).

At 210, the frictionless loyalty identifier integration manager receive an image of a face (e.g., a facial image) for a customer who is performing a transaction at a transaction terminal 120. The customer has already enrolled at 210 for frictionless loyalty integration for transactions of the customer.

In an embodiment, at 211, the frictionless loyalty identifier integration manager receives the image via an API call made after the image is captured by a transaction manager 123. The transaction manager 123 processes a transaction workflow for the transaction on the terminal 120.

In an embodiment, at 212, the frictionless loyalty identifier integration manager receives a live video feed of the customer from a camera adjacent to the terminal 120 and the camera is facing the customer so as to capture the face of the customer at the terminal 120. The frictionless loyalty identifier integration manager selects the image from a plurality of image frames associated with the video feed.

At 220, the frictionless loyalty identifier integration manager passes the image as input to a trained MLM 114. The MLM 114 was trained on an initial facial image of the customer during enrollment as was discussed above with process flow 100A of FIG. 1A and system 100C of FIG. 1C.

At 230, the frictionless loyalty identifier integration manager receives a score as output from the MLM 114. That is, the MLM 114 is trained on features of the face of the customer to score the features. For example, a distance calculated between the customers' eyes, distance between end of nose and lips, sizes of the eyes, lips, nose, ears, distance from nose to ears, etc.; the biometric features are then scored and the trained MLM 114 returns the score as output to the frictionless loyalty identifier integration manager.

At 240, the frictionless loyalty identifier integration manager matches the score returned to a loyalty identifier. The loyalty identifier was registered to the customer during customer enrollment along with a customer facial image that the MLM 114 was trained on.

In an embodiment, at 241, the frictionless loyalty identifier integration manager compares the score outputted by the trained MLM 114 to a predefined range and matches the score to a customer record. The customer record includes the score and the loyalty identifier. For example, if the score is 85 returned from the MLM 114 for the facial image and the predefined range is +/−5, the frictionless loyalty identifier integration manager matches a score in the record having values between 80 and 90.

At 250, the frictionless loyalty identifier integration manager injects the loyalty identifier into the transaction causing a loyalty system 134 to provide loyalty details for the customer during the transaction. This integration of the loyalty identifier into the transaction also causes transaction details for the transaction to be associated with a loyalty account linked to the loyalty identifier of the customer.

In an embodiment, at 251, the frictionless loyalty identifier integration manager issues an API call that inserts the loyalty identifier into a transaction workflow being processed by a transaction manager 123 of the terminal 120. In an embodiment of 251 and at 252, this causes the transaction manager 123 to interact with the loyalty system 134 when the loyalty identifier is inserted into the transaction workflow to obtain the loyalty details associated with the loyalty identifier. In an embodiment of 252 and at 253, this causes the transaction manager 123 to personalize the transaction for the customer based on the customer's loyalty details. In an embodiment of 253 and at 254, this further causes the transaction manager 123 to associate the transaction details for the transaction with the loyalty identifier for subsequent linking and/or updating to the loyalty account managed by the loyalty system for the customer. Complete loyalty integration is achieved for the customer, the retailer, and the transaction.

In an embodiment, at 260, the frictionless loyalty identifier integration manager maintains the loyalty identifier and the score from the MLM 114 in a record of a data store with other records. Each record includes a different loyalty identifier for a different customer and a different score returned from the MLM 114 based on a corresponding facial image of the corresponding customer being provided during training as input to the MLM 114.

In an embodiment, at 270, the frictionless loyalty identifier integration manager processes (e.g., 210-260) as a micro service of a micro server architecture for transaction processor. The micro service is callable via an API from a transaction workflow being processed for transactions and the micro service injects the customer's loyalty identifier into the workflow for integrating the customer's loyalty account into the transaction processing. This permits the transaction manager 123 to personalize the transaction for the customer; for example, customizing settings for the transaction interface screens with font sizes, communication in a customer's preferred written and spoken language, using a registered and default payment method for transaction payment, delivering a transaction receipt through a preferred communication channel of the customer (e.g., text, email, etc.) etc.

FIG. 3 is a flow diagram of another method 300 for processing frictionless loyalty vision transaction integration during a checkout, according to an example embodiment. The software module(s) that implements the method 300 is referred to as a “loyalty integrator.” The loyalty integrator is implemented as executable instructions programmed and residing within memory and/or a non-transitory computer-readable (processor-readable) storage medium and executed by one or more processors of one or more devices. The processor(s) of the device(s) that executes the loyalty integrator are specifically configured and programmed to process the loyalty integrator. The loyalty integrator has access to one or more network connections during its processing. The network connections can be wired, wireless, or a combination of wired and wireless.

In an embodiment, the device that executes the loyalty integrator is cloud 110. In an embodiment, the device that executes the loyalty integrator is server 110. In an embodiment, the device that executes the loyalty integrator is retail server 130. In an embodiment, the loyalty integrator is provided to a retail server 130, retailer service, and/or retail system as a SaaS.

In an embodiment, the loyalty integrator is all of, or some combination of 113, 114, and/or method 200. The loyalty integrator another and, in some ways, enhanced processing perspective from that which was discussed above with process flow 100A of FIG. 1A, process flow 100B of FIG. 1B, system 100C of FIG. 1C, and/or the method 200 of the FIG. 2.

At 310, loyalty integrator receives a first facial image of a customer during a first transaction at a transaction terminal 120 from a transaction workflow. The transaction workflow is being processed by a transaction manager 123 on the first terminal 120 for the first transaction.

At 320, the loyalty integrator identifies a loyalty identifier for the customer from the transaction workflow. The loyalty identifier can be supplied simultaneously with the first facial image by the transaction workflow or can be provided separately once it is obtained by the transaction workflow for the customer.

In an embodiment, at 321, the loyalty integrator receives the loyalty identifier from the transaction workflow based on the customer supplying the loyalty identifier for the first transaction. The customer can swipe or scan a loyalty card to provide the loyalty identifier, or the customer can enter loyalty identifying information into a transaction interface screen to cause transaction manager 123 to search for the loyalty identifier using the loyalty identifying information. This is a case where the customer already has a loyalty account and is enrolling for frictionless loyalty integration.

In an embodiment, at 322, the loyalty integrator receives the loyalty identifier from the transaction workflow based on a loyalty system 134 that registers the customer for a loyalty account during the second transaction. Loyalty registration manager 124 interacts with loyalty system 132 and obtains the loyalty identifier, which is then inserted into the transaction workflow and provided to loyalty integrator. This is a case where the customer registers for a new loyalty account during the second transaction and then enrolls for frictionless loyalty integration.

At 330, the loyalty integrator trains a MLM 114 on the first facial image to produce a score. The MLM 114 detects facial features of the customer and scores those features to produce as output a unique score for the customer's facial image.

At 340, the loyalty integrator inserts a customer record into a data store. The customer record includes the loyalty identifier and the score produced by the MLM 114 during training. It is noted that the facial image need not be retained by loyalty integrator following training of the MLM 114 such that the record is a link from the score to the loyalty identifier, which was identified at 320.

In an embodiment, at 341, the loyalty integrator maintains a threshold range with each customer record of the data store or with the data store as a whole for all customer records of the data store. The threshold range can account for slight differences in subsequent facial images taken of the customer for subsequent transaction that cause the MLM 114 to produce different variations that the original training score. For example, a threshold range can be +/−5 for the score of a particular customer associated with a particular customer record or the threshold range can be +/−5 for each of the customer records maintained in the data store.

At 350, the loyalty integrator receives a second facial image of the customer from the transaction workflow during a second transaction at the first terminal 120 or a different terminal 120. 310-340 enrolled the customer in frictionless loyalty integration, 340-370 describe processing of the loyalty integrator after a customer is enrolled.

In an embodiment, at 351, the loyalty integrator receives the second facial image from the different terminal for the second transaction. The different terminal can be a different terminal from the first terminal within a same store of a given retailer or can be a different terminal from the first terminal within a different store of the given retailer.

At 360, the loyalty integrator provides the second facial image to the MLM 114. The loyalty integrator receives a candidate score as output from the MLM 114 based on facial features detected and scored by the MLM 114 from the second facial image of the customer.

At 370, the loyalty integrator matches the candidate score to the score of the customer record within the data store. In an embodiment, at 371, the loyalty integrator adjusts the candidate score by a threshold range and searches the data store to match the score of the customer record with the candidate score. For example, if the candidate score is 85 and the threshold range is +/−5, the loyalty integrator searches records of the data store for values between 80 and 90 to identify the customer record of the customer and to obtain the corresponding loyalty identifier of the customer.

At 380, the loyalty integrator injects the loyalty identifier of the customer record into the transaction workflow for the second transaction. This is done without the customer taking any affirmative actions to associate the second transaction with the customer's loyalty identifier and without the customer making any touch-based contacts with any surfaces of the first terminal 120 or the different terminal 120.

In an embodiment, at 381, the loyalty integrator personalizes the second transaction for the customer based on loyalty details returned for the loyalty identifier by a loyalty system 134. For example, transaction manager 123 detects the loyalty identifier in the transaction workflow and interacts with loyalty system 134 to identify the loyalty account and obtain the loyalty details. The loyalty details cause transaction manager 123 to personalize the second transaction for the customer.

In an embodiment, at 382, the loyalty integrator causes a loyalty system 134 to update with transaction details for the second transaction. This is achieved because the loyalty identifier is associated with the transaction details within the transaction workflow such that subsequent workflows and processes that operating on the transaction details update the customer's loyalty account with the transaction details within the loyalty system 134 using the linked loyalty identifier.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving, in connection with a transaction at a transaction terminal, an image of a face of a customer;
passing the image as input to a machine-learning model (MLM);
receiving a score as output from the MLM;
matching the score to a loyalty identifier for the customer; and
injecting the loyalty identifier into the transaction causing a loyalty system to provide loyalty details for the customer during the transaction and causing transaction details for the transaction to be associated with a loyalty account linked to the loyalty identifier.

2. The method of claim 1, wherein receiving further includes receiving the image via an application programming interface (API) call made after the image is captured by a transaction manager that processes a transaction workflow for the transaction.

3. The method of claim 1, wherein receiving further includes receiving a video feed of the customer and selecting the image from a plurality of image frames associated with the video feed.

4. The method of claim 1, wherein matching further includes comparing the score to a predefined range and matching the score to a customer record, wherein the customer record comprises the score and the loyalty identifier.

5. The method of claim, wherein injecting further includes issuing an application programming interface call that inserts the loyalty identifier into a transaction workflow being processed by a transaction manager of the transaction terminal.

6. The method of claim 5, wherein issuing further includes causing the transaction manager to interact with the loyalty system when the loyalty identifier is inserted into the transaction workflow and to obtain the loyalty details from the loyalty system using the loyalty identifier.

7. The method of claim 6, wherein causing further includes causing the transaction manager to personalize the transaction for the customer based on the loyalty details.

8. The method of claim 7, wherein causing further includes causing the transaction manager to associate the transaction details for the transaction with the loyalty identifier for subsequent linking or updating to the loyalty account managed by the loyalty system.

9. The method of claim 1 further comprising, maintaining the loyalty identifier and the score from the MLM in a record of a data store with other records, each other record comprises a different loyalty identifier and a different score returned from the MLM based on a corresponding facial image of the corresponding customer.

10. The method of claim 1 further comprising, processing the method as a micro service of a micro service architecture for transaction processing, the micro service callable from a transaction workflow processed by the transaction terminal to insert the loyalty identifier into the transaction workflow when the transaction is being processed by the transaction terminal.

11. A method, comprising:
receiving a first facial image of a customer during a first transaction at a transaction terminal from a transaction workflow being processed on the first transaction terminal for the first transaction;
identifying a loyalty identifier for the customer from the transaction workflow;
training a machine-learning model (MLM) on the first facial image to produce a score from features of a face of the customer depicted in the facial image;
inserting a customer record into a data store, the customer record comprises the loyalty identifier and the score;
receiving a second facial image of the customer from the transaction workflow during a second transaction at the transaction terminal or a different transaction terminal;
providing the second facial image to the MLM and receiving a candidate score as output from the MLM;
matching the candidate score to the score of the customer record within the data store; and
injecting the loyalty identifier of the customer record into the transaction workflow for the second transaction without the customer taking any affirmative actions to associate the second transaction with the loyalty identifier.

12. The method of claim 11, wherein identifying further includes receiving the loyalty identifier from the transaction workflow based on the customer supplying the loyalty identifier.

13. The method of claim 11, wherein identifying further includes receiving the loyalty identifier based on a loyalty system assigning to the customer, wherein the loyalty system registered the customer for a loyalty account during the first transaction and assigns the loyalty identifier within the transaction workflow.

14. The method of claim 11, wherein inserting further includes maintaining a threshold range with each of the customer records of the data store or with the data store as a whole, wherein the threshold range used to adjust corresponding scores subsequent returned from the MLM.

15. The method of claim 11, wherein receiving the second facial image further includes receiving the second facial image from the different transaction terminal for the second transaction.

16. The method of claim 11, wherein matching further includes adjusting the candidate score by a threshold range and searching the data store to match the score of the customer record within the data store.

17. The method of claim 11, wherein injecting further includes personalizing the second transaction for the customer based on loyalty details associated with the loyalty identifier maintained in a loyalty system.

18. The method of claim 11, wherein injecting further includes causing a loyalty system to be updated with transaction details associated with the second transaction.

19. A system, comprising:
a cloud server comprising at least one processor and a non-transitory computer-readable storage medium, the non-transitory computer-readable storage medium comprising executable instructions, wherein the executable instructions, when executed by the at least one processor, cause the at least one processor to perform operations comprising:
training a machine-learning model (MLM) on an image captured of a customer during a first transaction at a first transaction terminal to produce a score for facial features of a face of the customer from the image;
linking the score to a loyalty identifier associated with the customer;
receiving a second image of the face of the customer at a second transaction terminal during a second transaction of the customer;
providing the second image to the MLM and receiving a candidate score on the facial features;
matching the candidate score to the score and obtaining the loyalty identifier; and
injecting the loyalty identifier into the second transaction causing loyalty details associated with a loyalty account of the loyalty identifier to be processed for the customer and causing the second transaction to be personalized for the customer at the second transaction terminal during the second transaction without the customer performing any affirmative action to associate the loyalty identifier with the second transaction.

20. The system of claim 19, wherein the terminals comprise point-of-sale (POS) terminals, self-service terminals (SSTs), automated teller machines (ATMs), or any combination of the POS terminals, the SSTs, and the ATMs.
